(19) United States
(12) Patent Application Publication
(10) Pub. No.: US 2012/0057222 A1
(43) Pub. Date: Mar. 8, 2012

(54) SINGLE CRYSTAL OF MAGNESIUM FLUORIDE, OPTICAL MEMBER AND OPTICAL ELEMENT COMPRISING THE SAME

(76) Inventors: Yasuhiro HASHIMOTO, Shunan-shi (JP); Masao Ariyuki, Shunan-shi (JP); Naoto Mochizuki, Shunan-shi (JP); Tsuguo Fukuda, Sendai-shi (JP)

(21) Appl. No.: 12/875,767

(22) Filed: Sep. 3, 2010

(51) Int. Cl. G02B 5/30; C01F 5/28; B32B 1/00

(52) U.S. Cl. 359/352; 428/174; 423/490

(57) ABSTRACT

A single crystal of magnesium fluoride having a large diameter and excellent optical properties such as internal transmittance and long term laser durability, and suited for use as optical elements for exposing apparatus. The single crystal of magnesium fluoride is of a cylindrical shape having a straight body portion of a diameter of not smaller than 10 cm, has an internal transmittance of at least 85%/cm at 120 nm and at least 98%/cm at 193 nm and has, desirably, an induced absorption of not larger than 0.0030 absorption/cm at 255 nm and, particularly desirably, not larger than 0.0010 absorption/cm. at 255 nm immediately after the irradiation with 2 million shorts of an ArF excimer laser of an energy density of 30 mJ/cm² and 2000 Hz. The invention further provides an optical element for optical lithography comprising the single crystal and an optical member for vacuum ultraviolet ray transmission comprising the single crystal.

### BACKGROUND OF THE INVENTION

1. Field of the Invention

This invention relates to a single crystal of magnesium fluoride of a large size having high optical properties, that can be preferably used as an optical member for vacuum ultraviolet ray transmittance and, particularly, as an optical element for optical lithography such as polarizing plates for illumination systems.

2. Description of the Prior Art

A single crystal of a metal fluoride such as calcium fluoride or magnesium fluoride has a transmittance, low refractive index and low dispersion over a wide range of wavelength band of from vacuum ultraviolet rays through up to infrared regions, and also excels in chemical stability. Therefore, it has been used as an optical material over a wide region, such as window material, lens and prism. Especially, it has been expected to be used as a window material, lens for light source, lens for illumination system, lens for projection system and polarizing plate in such a device as a reduced projection type exposing apparatus that uses an ArF laser (193 nm) source or an F₂ laser (157 nm) source that has been developed as a source of light of short wavelengths of the next generation in the optical lithography technology.

A high image-forming performance (resolution, depth of focus) is required for the lenses used in the highly fine exposing apparatus. Therefore, the material used for the lenses must meet high degree of optical properties, such as small residual stress and strain (small distribution of birefringence), a high transmittance, a large long term laser durability and little lattice defects.

If the residual stress and strain are large, birefringence increases correspondingly, and the lens becomes not suited for use in the projection system of the exposing apparatus where very strict optical properties are required. If there are much lattice defects, the transmittance decreases due to the scattering of light, contrast decreases, flare and ghost occur, and properties of the material greatly decrease. Therefore, like when there are much residual stress and strain, the material becomes not suited for optical use where high degree of optical properties are required. In recent years, further, the intensity of laser energy is ever increasing and it has been more desired to prevent a decrease in the transmittance of the lens (long term laser durability) caused by the repetitive irradiation with laser.

The single crystal of magnesium fluoride has a tetragonal crystal structure, can polarize light that transmits through depending on the crystal azimuth, and has already been used as a polarizing material. At present, the laser being used has a small energy intensity, and there is no serious problem concerning the long term laser durability. In the field of optical lithography, however, there is a project for effecting the exposure to light for a short period of time by using a laser of a high energy intensity in order to improve the throughput, and it is becoming necessary to use a single crystal having ever excellent long term laser durability. As compared to quartz or fused silica used as an optical member for optical lithography, the single crystal of fluoride has a very large band gap and, therefore, has a very high transmittance in the ultraviolet/vacuum ultraviolet (UV/VUV) regions and a theoretically large long term laser durability. Because of these reasons, the single crystal has now been expected to substitute for the presently used products of quartz or fused silica, and has now been used in some fields.

To increase the degree of integration of semiconductor elements, further, it has been demanded to finely form the exposure patterns, and one of the solutions is to develop a technology for polarized illumination. The polarizing element used in this technology is, at present, a rock crystal. As described above, however, a single crystal of magnesium fluoride has been expected from the standpoint of long term laser durability.

Further, as for the material such as laser-transmitting lens in the field of the optical lithography, it becomes necessary to use a member having a large diameter, i.e., a single crystal having a large diameter to meet the shape of the exposing apparatus. Besides, the material must be industrially and inexpensively supplied.

So far, the single crystal of metal fluoride has, generally, been produced by the crucible depression method (also called Bridgman method). Here, the crucible depression method is a method of growing a single crystal in the crucible by gradually lowering a melt of a starting material for producing single crystal in the crucible together with the crucible while cooling the melt.

Here, however, the single crystal of magnesium fluoride produced by the crucible depression method is such that the single crystal is formed in a state where the surface of the starting melt is in contact with the inner wall of the crucible. Therefore, strain in the single crystal which is an anisotropic crystal becomes no longer tolerated resulting in the formation of polycrystals or in the occurrence of cracks which turn out to be whitened. At present, therefore, it is unable to produce a complete single crystal having a large diameter.

Here, the internal transmittance of a single crystal of magnesium fluoride that has now been reported is, when converted into a thickness of 1.0 cm, about 77.11%/cm at a wavelength of 120 nm and about 92.74%/cm at a wavelength of 190 nm. As a value that represents the long term laser durability of the single crystal, further, there is a description of a laser induced absorption at 255 nm of about 0.08 absorption/4.2 cm immediately after the irradiation with 5 million shots of ArF excimer laser of energy density of 40 mJ/cm² and 4000 Hz. If converted into a value of laser induced absorption specified by the present invention described later, the above value becomes about 0.0076 absorption/cm. Therefore, there has not still been obtained a single crystal of magnesium fluoride that exhibits sufficient long term laser durability (patent document 1). The patent document 1 has no concrete disclosure related to the method of producing the single crystal of magnesium fluoride.

There has further been reported the production of a single crystal of magnesium fluoride of a diameter of 25 cm and a thickness of 5.0 cm by the Czochralski method without, however, any description of minute production conditions, long term laser durability of the obtained single crystal or internal transmittance (patent document 2).

In addition to the above, there are documents that refer to the magnesium fluoride as a single crystal of metal fluoride used in the optical lithography technology, but there is found no document that produces the magnesium fluoride of a large diameter on a level of Working Examples (patent documents 3 to 6). This is because, as described above, it is considered that the Bridgman method is not capable of substantially producing the magnesium fluoride of a large diameter.

A patent document 6 discloses setting a temperature gradient to be not more than 10/cm at the time of producing a single crystal of metal fluoride (inclusive of magnesium fluoride) by the Bridgman method. The effect is to improve the uniformity of refractive index by decreasing dispersion in the distribution of impurities in the transverse (horizontal) direction, but there is described no effect upon the transmittance. Besides, there is a distinctive difference in the principle between the Bridgman method and the Czochralski method. Therefore, it cannot be said that the temperature gradient similarly affects the two methods.

### PATENT DOCUMENTS

[Patent document 1] US2003/0007536
[Patent document 2] Japanese Patent No. 4174086
[Patent document 3] US2003/0070606
[Patent document 4] US2004/0031436
[Patent document 5] US2004/0154527
[Patent document 6] JP-A-2006-315915

### SUMMARY OF THE INVENTION

The present inventors have attempted to grow a single crystal of magnesium fluoride having excellent optical properties and a large diameter by employing a single crystal pulling method (also called Czochralski method) in which there is no direct contact between a single crystal growth point and the inner wall of the crucible and which, therefore, is not affected by the direct contact. Under the production conditions employed for the single crystal of metal fluoride such as a single crystal of calcium fluoride, however, the obtained cylindrical single crystal possessed a diameter of only about 5.0 cm at the greatest at the straight body portion thereof.

In order to solve the above problems, therefore, the present inventors have keenly continued a study. As a result, the inventors have discovered that a temperature profile in the single crystal growth area in the Czochralski furnace plays a very important role for obtaining a single crystal of magnesium fluoride having good transmittance despite of its large diameter, and that a long term laser durability is greatly affected by the kind and amount of a scavenger, and have thus completed the present invention.

That is, according to a first invention, there is provided a single crystal of magnesium fluoride of a cylindrical shape having a straight body portion of a diameter of not smaller than 10 cm, and having an internal transmittance of at least 85.00%/cm at 120 nm and at least 98.00%/cm at 193 nm.

In the single crystal of magnesium fluoride of the invention, it is desired that a laser induced absorption at 255 nm is not larger than 0.0030 absorption/cm immediately after the irradiation with 2 million shots of an ArF excimer laser of an energy density of 30 mJ/cm² and 2000 Hz.

According to a second invention, there is provided a single crystal of magnesium fluoride having a laser induced absorption at 255 nm of not larger than 0.0030 absorption/cm immediately after the irradiation with 2 million shots of an ArF excimer laser of an energy density of 30 mJ/cm² and 2000 Hz.

In the single crystal of magnesium fluoride of the second invention, it is desired that a laser induced absorption is not larger than 0.0010 absorption/cm.

According to the invention, further, there is provided an optical member for vacuum ultraviolet ray transmittance, comprising the single crystal of magnesium fluoride of the first invention or the second invention.

According to the invention, further, there is provided an optical element for optical lithography, comprising the single crystal of magnesium fluoride of the first invention or the second invention.

According to the present invention, there is provided a single crystal of magnesium fluoride of a large diameter having excellent internal transmittance and long term laser durability. Therefore, the single crystal of magnesium fluoride can be preferably used as an optical member for use in an exposing apparatus in the technical field of optical lithography. The single crystal of magnesium fluoride is, particularly, valuable as a polarizer element in a polarized illumination system which is useful for forming finer patterns.

### BRIEF DESCRIPTION OF THE DRAWINGS

FIG. 1 is a schematic view of the structure of a single crystal growing furnace for obtaining a single crystal of magnesium fluoride under a condition of a mild temperature gradient;

FIG. 2 is a schematic view of the structure of a single crystal growing furnace for obtaining a single crystal of magnesium fluoride under a condition of a steep temperature gradient (conventional furnace);

FIG. 3 is a diagram showing the simulated results of temperature gradients at the central portions of the crystals in the longitudinal direction in the Experiments;

FIG. 4 is a diagram showing the simulated results of temperature gradients in the peripheral portions of the crystals in the longitudinal direction in the Experiments;

FIG. 5 is a diagram showing the simulated results of temperature gradients in the horizontal direction (transverse direction) which is the same as the surface of the starting melts in the Experiments;

FIG. 6 is a diagram showing VUV transmittance of the single crystals obtained in the Experiments 1, 2 and 5;

FIG. 7 is a Laser induced absorption spectrum of Experiment 1;

FIG. 8 is a Laser induced absorption spectrum of Experiment 2;

FIG. 9 is a Laser induced absorption spectrum of Experiment 5;

FIG. 10 is a diagram showing VUV transmittances of the single crystals obtained in the Experiments 3,5,9 and 10;

FIG. 11 is a Laser induced absorption spectrum of Experiment 3;

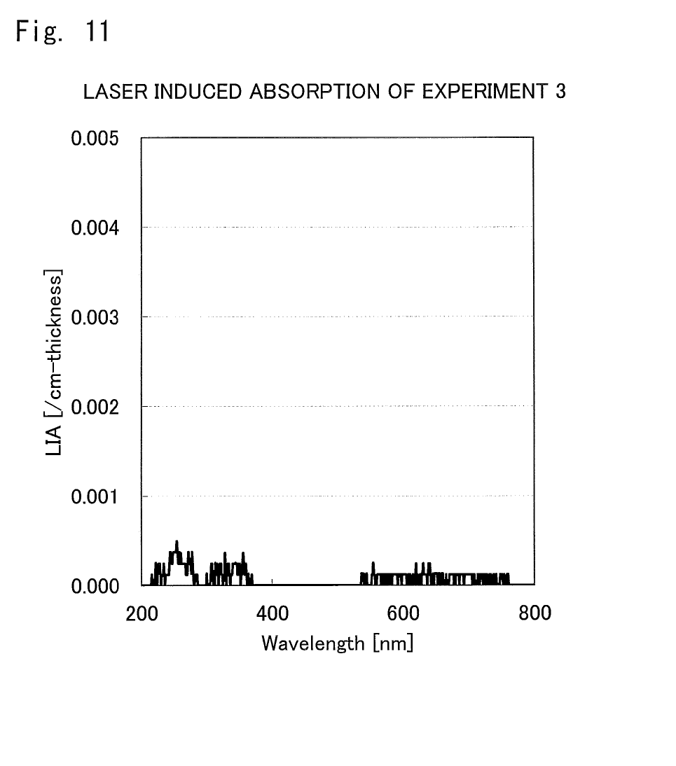

FIG. 12 is a Laser induced absorption spectrum of Experiment 9;

FIG. 13 is a Laser induced absorption spectrum of Experiment 10;

FIG. 14 is a diagram showing VUV transmittances of the single crystals obtained in the Experiments 5 to 8;

FIG. 15 is a Laser induced absorption spectrum of Experiment 6;

FIG. 16 is a Laser induced absorption spectrum of Experiment 7;

FIG. 17 is a Laser induced absorption spectrum of Experiment 8.

### DESCRIPTION OF THE PREFERRED EMBODIMENTS

### [Single Crystal of Magnesium Fluoride]

This invention relates to a single crystal of magnesium fluoride of a cylindrical shape having a diameter of not smaller than 10 cm at the straight body portion thereof. Though there is no limitation on the production method, the above single crystal was obtained for the first time by the present inventors relying on the single crystal pulling method that will be described later. The single crystal of magnesium fluoride of the invention encompasses an as-grown single crystal (ingot) obtained by the single crystal pulling method, a single crystal obtained by heat-treating (annealing) the ingot, and a single crystal (disk) of the shape of a disk obtained by cutting. In the case of the ingot obtained by the single crystal pulling method, usually, the upper part of the straight body portion is constituted by a shoulder portion of a conical portion and the lower part of the straight body portion is constituted by a tail portion of a conical portion. Therefore, the diameter refers to an average diameter of a cylindrical portion at the central straight body portion where the diameter is nearly constant.

It is essential that the diameter is not smaller than 10 cm. At present, a single crystal having a maximum diameter of 15 cm can be stably produced. The length of the straight body portion can be arbitrarily varied. Usually, there is obtained a single crystal having a diameter of 10 to 17 cm.

The single crystal has an internal transmittance of at least 85.00%/cm at 120 nm and at least 98.00%/cm at 193 nm. The internal transmittance is a transmittance factor of an optical member itself upon removing the effect of reflection loss on the surface of the material, and is specific to the material.

Upon measuring a relationship between the wavelength and the refractive index, the reflection loss can be calculated from the Sellmeier's dispersion formula. Refractive indexes were measured for 15 wavelengths of from 633 nm to 185 nm, and the reflection loss of magnesium fluoride was calculated from a formula obtained by completing the Sellmeier's dispersion formula. The reflection loss is, for example, 10.91% at 120 nm and 6.12% at 193 nm.

The higher the internal transmittance, the better the quality and the single crystal is highly valuable as an optical material. According to the present invention, the internal transmittance at 120 nm is, desirably, at least 90.00%/cm, more desirably, at least 92.00%/cm and, particularly desirably, at least 94.00%/cm. Further, the internal transmittance at 193 nm is, desirably, at least 99.00%/cm.

The single crystal of magnesium fluoride provided by the present invention has a laser induced absorption at 255 nm of not larger than 0.0030 absorption/cm immediately after the irradiation with 2 million shots of an ArF excimer laser of an energy density of 30 mJ/cm² and 2000 Hz and, particularly desirably, a laser induced absorption at 255 nm of not larger than 0.0010 absorption/cm immediately after the irradiation with 2 million shorts of the ArF excimer laser of an energy density of 30 mJ/cm² and 2000 Hz.

The induced absorption is the one obtained by converting, into an absorbance, a difference between an ultraviolet visible ray transmittance of before being irradiated with the laser and an ultraviolet visible ray transmittance of immediately after irradiated with the laser under predetermined conditions, and is an index that represents a long term laser durability. The smaller this value, the more excellent the long term laser durability.

### [Growing the Single Crystal of Magnesium Fluoride]

Concretely described below is the production of the single crystal of magnesium fluoride of the invention by the single crystal pulling method.

The single crystal pulling method is a known method of producing a single crystal of metal fluoride by dipping a seed crystal held at the lower end of a pulling shaft in a melt of a metal fluoride in a crucible, and pulling up the pulling shaft letting a single crystal grow under the seed crystal. A basic structure of the furnace used for the method of obtaining the single crystal of magnesium fluoride of the present invention has been disclosed in US2008/0000413.

That is, a single crystal of magnesium fluoride having a large diameter and excellent transmittance can be produced by using a crystal-growing furnace that employs a crucible of a double structure comprising an outer crucible and an inner crucible having a communication hole through which the melt can move. The crucible of the double structure was developed to grow a large crystal of good quality by decreasing natural convection of the melt and decreasing a change in the temperature environment by eliminating a change in the relative position on the solid-liquid interface in the furnace, and can be favorably used for growing the single crystal of the present invention. As the heating device, there can be used a resistance heater which is usually installed on the inside of the heat-insulating wall or a high-frequency induction heater which is usually installed on the outside of the heat-insulating wall.

To obtain a single crystal of magnesium fluoride having a large diameter and optical properties of high quality by using the above known crystal-growing furnace, however, it becomes very important to control the temperature gradient in the longitudinal direction in the single crystal growth area in the single crystal-growing furnace. Namely, the temperature gradient in the single crystal growth area must be set to be 5 to 10 deg/cm and, desirably, 5 to 8 deg/cm. When a single crystal of calcium fluoride is grown by the pulling method, the temperature gradient is, usually, 10 to 14 deg/cm. Even if a single crystal of magnesium fluoride is grown under the condition of such a large temperature gradient, however, the single crystal having a large diameter and high quality is not obtained.

When the temperature gradient is decreased, a single crystal of magnesium fluoride having a large diameter is obtained probably due to the reasons as described below. Namely, the magnesium fluoride exhibits properties of crystal lattice that vary depending upon the axis. Therefore, a difference in the coefficient of contraction due to the above difference tends to remain in the crystal as strain at the time of crystallization. Stress due to the strain causes the portion where tolerable amount is exceeded to become polycrystalline, or to crack so as to become whitened. When the temperature gradient is decreased, on the other hand, a period of time can be maintained which is long enough for liberating strain from the crystal at the time of crystallization presumably making it possible to obtain a single crystal of magnesium fluoride having a large diameter and excellent transmittance.

Upon employing the above-mentioned crucible of the double structure, a decrease in the melt in the inner crucible caused by the growth of crystal can be compensated by the rise of the outer crucible. This makes it possible to eliminate a change in the relative position of the solid-liquid interface (surface of melt) in the furnace. As a result, a change in the temperature gradient in the longitudinal direction can be suppressed from the start of crystal growth to the completion thereof, and the temperature gradient can be maintained in the above range.

The temperature gradient in the transverse direction may be the same as those for the single crystals of other metal fluorides such as calcium fluoride and is, usually, 0 to 1 deg/cm.

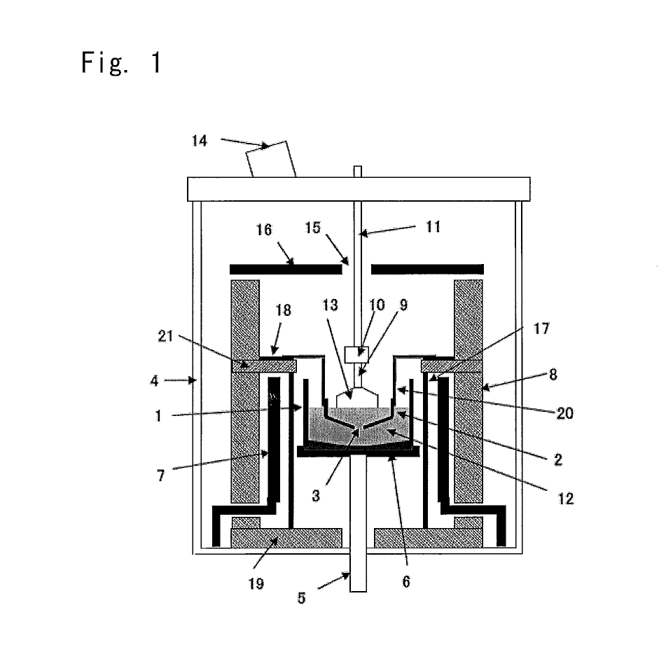

Though there is no particular limitation on the means for controlling the temperature gradient to lie in the above range narrower than the usually employed ranges, there can be used a method which controls the temperature gradient by adjusting the position of a heater (7) installed on the side portion in the growing furnace shown in FIG. 1 or a method which prevents a drop of temperature in the furnace by installing a heat-insulating lid member as designated at (21) in FIG. 1 at a portion higher than a position where it is expected that the single crystal is finally pulled up. The latter method is a simple method without requiring any particularly fine control operation.

The single crystal grows in the solid-liquid interface. In the present invention, therefore, the single crystal growth area refers, in the longitudinal direction, to the area from the surface where the seed crystal is brought in contact with the melt of magnesium fluoride, i.e., from the surface of the melt to the horizontal surface inclusive of a point where an upper end of a grown single crystal is present when the growth is finished. In an ordinary growing furnace, the single crystal growth area is a range corresponding to 1.5 times as great as the diameter of the single crystal with the point where the seed crystal contacts the melt as 0. The transverse direction is a range that corresponds to the diameter of the single crystal. The above temperature gradient may be attained at least in the single crystal growth area. The temperature gradient may have been attained over a wider range, as a matter of course.

It is very difficult to measure the temperature gradient in an atmosphere of a high temperature in which a fluorine-contained gas is present like in the method of producing magnesium fluoride of the invention that will be described later. The fluorine-contained gas violently corrodes metal wires of a thermocouple and, therefore, the precision of the thermocouple decreases with the passage of time. Just over the melt, in particular, the vaporized melt adheres on the metal wires and solidifies thereon making it difficult to take a correct measurement.

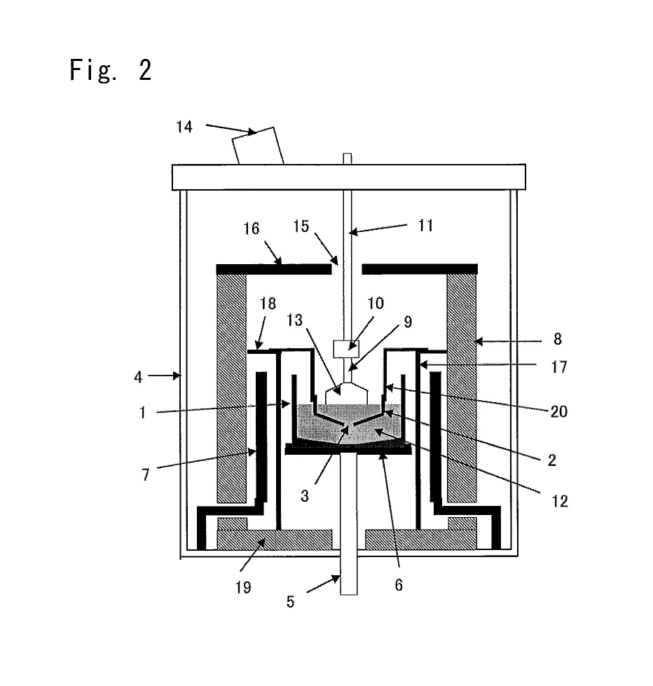

In the crystal-growing furnace of a high temperature, therefore, it is difficult to determine the gradient by measuring the temperature. Usually, therefore, the temperature gradient in the furnace is determined by simulation, i.e., by global numerical simulation. Concretely speaking according to the present invention, the center point of melt was simulated to be 1265 which is a melting point of magnesium fluoride in the constitution of FIGS. 1 and 2 by using “CrysMAS” (produced by Fraunhofer Institute for Integrates Systems and Device Technology) which has been widely used in the field of industries.

In conducting the simulation, values defaulted in the CrysMAS were used as physical values for Ar, SUS and heat-insulating member. As for the properties of the carbon member, values furnished by the manufacturer were used. Further, the shape factors that may affect the temperature gradient are described in the Experiments appearing later.

From the simulated results, there were calculated a temperature gradient vertically over the center of the melt and a temperature gradient at the periphery of the crystal.

Concretely described below is a particularly preferred method of producing a single crystal of magnesium fluoride of the present invention.

By controlling the temperature gradient in the single crystal growth area in the growing furnace as described above, it is made possible to produce a single crystal of magnesium fluoride of the invention having a large diameter and excellent internal transmittance. At the time of production, usually, oxygen and water (hereinafter referred to as “water and the like”) are removed by using a scavenger like when producing single crystals of other metal fluorides.

At the time of producing the single crystal of metal fluoride, water and the like that had been adhered (physically adhered, chemically adhered) to the heat-insulating members and furnace walls diffuse into the furnace, infiltrate into the melt of metal fluoride and, further, react with the metal fluoride to form an oxide thereof. The metal oxide is then taken into the crystal arousing such problems as decreased internal transmittance of the single crystal and deteriorated longterm laser durability. The scavenger is used to remove the effects of the oxide.

To obtain a single crystal of the invention, first, a solid scavenger is used. As the solid scavenger, there can be exemplified zinc fluoride, lead fluoride, polytetrafluoroethylene, silver fluoride and copper fluoride. Among them, however, zinc fluoride is preferred from the standpoint of removing impurities and environmental load. The solid scavenger is a fluoride. When heated in the growing furnace, therefore, the solid scavenger volatilizes and diffuses to easily come in contact with impurities such as water and the like adhered on the heat-insulating members and furnace walls.

The scavenger can be used by being introduced into the crucible together with the starting magnesium fluoride, by being introduced into a scavenger-introducing groove formed in a crucible or a crucible bedplate (e.g., see JP2009-040630), or by being introduced into a scavenger storage container installed near the crucible.

The solid scavenger is used, usually, in an amount of about 0.005 to about 0.2 mol % with respect to the starting magnesium fluoride. By using the solid scavenger in an amount in a range of 0.006 to 0.150 mol % with respect to the starting material, further, the long term laser durability can be improved. The long term laser durability can be evaluated by measuring the laser induced absorption. By using the solid scavenger in an amount in the above range, the laser induced absorption can be decreased to be not larger than 0.0030 absorption/cm.

Usually, as is well known, the starting magnesium fluoride is introduced into the crystal-growing furnace after having been refined by removing water and the like therefrom as much as possible with various kinds of scavengers.

Therefore, the amount of the solid scavenger is the amount that is introduced into the crystal-growing furnace together with the refined starting magnesium fluoride, and does not include the scavenger that is used for refining the starting magnesium fluoride.

The starting magnesium fluoride refined by known means is introduced into the outer crucible (1) in the growing furnace. The solid scavenger is introduced into the outer crucible in the growing furnace, into the crucible, into the scavenger-introducing groove formed in the crucible bedplate, or into the scavenger storage container installed near the crucible. Next, prior to conducting the melting, the heat treatment is conducted under reduced pressure to remove impurities such as water and the like adhered on the starting magnesium fluoride, heat-insulating members and furnace walls. After having removed the adsorbed water and the like to a sufficient degree by heating, the starting magnesium fluoride is melted and a single crystal is pulled up from the melt.

To obtain further improved long term laser durability or, concretely, to decrease the laser induced absorption to be not larger than 0.0010 absorption/cm, it is desired to use the gaseous scavenger in combination with the solid scavenger prior to melting the starting magnesium fluoride. If the gaseous scavenger is used in a proper amount, it becomes possible to obtain a single crystal of magnesium fluoride having a laser induced absorption of not larger than 0.0005 absorption/cm.

As the gaseous scavenger, there can be exemplified hydrocarbon fluoride gases such as carbon tetrafluoride, carbon trifluoride and ethane hexafluoride, fluorine-contained gases such as fluorine (F₂) and carbonyl fluoride. Among them, a hydrocarbon fluoride gas is desired from the standpoint of easy handling and, particularly, carbon tetrafluoride is desired since it is relatively inexpensively available in a highly pure form.

If a particularly preferred procedure is concretely described, first, the temperature in the furnace is elevated to not lower than 200 but lower than a temperature at which the gaseous scavenger that is used starts working. For example, if the gaseous scavenger is carbon tetrafluoride, the temperature at which the carbon tetrafluoride starts working as a scavenger is about 900. In this step, therefore, the temperature is elevated to lower than 900 and, preferably, up to about 600. At the time of heating, the interior of the furnace is evacuated by using a vacuum pump so that the absolute pressure in the furnace is maintained to be not higher than 10⁻³ Pa. Next, the gaseous scavenger is introduced into the crystal-growing furnace and the interior of the crystal-growing furnace is heated to be not lower than a temperature at which the scavenger starts working. Due to the rise of temperature, the scavenger works to remove water and the like that could not be removed by the evacuation.

Here, it is desired that the gaseous scavenger is introduced in such an amount that the partial pressure thereof in the furnace is in a range of 2 to 50 kPa and, particularly preferably, 3 to 10 kPa. In order to easily adjust the rate of feeding the gaseous scavenger, it is desired that the gaseous scavenger is introduced being diluted with an inert gas such as argon gas or helium gas. The ratio of dilution is from about 1.5 times to about 30 times and, preferably not more than 25 times and, more preferably, not more than 5 times. The amount of introducing the gaseous scavenger and the diluting gas is, desirably, such that the pressure in the furnace is in a range of 10 to 101 kPa.

When the gaseous scavenger is used, the temperature is further elevated after the gaseous scavenger has been introduced to melt the starting magnesium fluoride. When the gaseous scavenger is not used, on the other hand, an inert gas such as argon is introduced instead of the gaseous scavenger and, thereafter, the starting magnesium fluoride is melted.

The gaseous scavenger and/or the inert gas are introduced into the furnace prior to melting the starting magnesium fluoride. This is to suppress the volatilization of magnesium fluoride. The volatilized magnesium fluoride solidifies at a low-temperature portion in the furnace (e.g., on the ceiling plate), and a solidified matter often falls down into the melt of the starting material. If such a falling down frequently occurs, it becomes difficult to grow the crystal maintaining stability.

After the melt of magnesium fluoride is obtained as described above, a seed crystal is brought in contact with the melt and a single crystal is pulled up.

The temperature at the time of pulling up the single crystal is not lower than 1265 and is, preferably, 1265 to 1365 as measured at the bottom portion of the crucible. Further, it is desired that the temperature is elevated to the above temperature at a rate of 10 to 500/hour.

The seed crystal used for the single crystal pulling method is a single crystal at least with its end portion being magnesium fluoride. The azimuth of end plane of the seed crystal is suitably selected from the plane (100), plane (001) and plane (111) of the chiefly grown plane of the as-grown single crystal that is to be produced.

In growing the single crystal, it is desired that the seed crystal is turned about the pulling axis at a rotational speed of 0.1 to 40 turns/min. and, more preferably, 1 to 10 turns/min. Accompanying the turn of the seed crystal, further, the outer crucible, too, may be turned at a similar rotational seed in a direction opposite to the direction of rotation of the seed crystal.

In pulling up the single crystal, it is important that the temperature gradient in the single crystal growth area is maintained in a range of 5 to 10 deg/cm. According to the study conducted by the present inventors, if the temperature gradient does not lie in this range, the single crystal fails to have good transmittance in the short wavelength zone or the single crystal having a diameter of not smaller than 10 cm is not grown.

The single crystal of a desired size is pulled up and is, thereafter, cooled down to a temperature at which it can be taken out from the furnace. If the temperature is cooled down too sharply, the obtained single crystal may develop large strain and, in an extreme case, may be broken due to thermal shock. After the crystal is grown, therefore, the rate of cooling down is, desirably, 0.1 to 3/min.

### [After-Treatment]

The as-grown single crystal obtained by the above method is, usually, subjected to the annealing to remove strain present therein. An ingot that is grown as described above and is taken out from the furnace may be subjected to the annealing. To efficiently conduct the annealing, however, the ingot may be cut into disks of a suitable size and may then be annealed. After cut, further, the cut surfaces may, desirably, be polished and washed prior to being annealed. As required, further, the ingot may be worked into any shape in addition to the disk shape and may be annealed.

### [Use]

The single crystal of magnesium fluoride of the invention has an excellent optical property and is useful as an optical member for transmission over a wide wavelength band of from infrared region through up to vacuum ultraviolet region. In particular, the single crystal of magnesium fluoride very favorably transmits vacuum ultraviolet rays over a range of 110 to 140 nm which are not transmitted or are very poorly transmitted by the ordinary single crystals, and is useful as an optical member for transmitting vacuum ultraviolet rays. By utilizing this property, the single crystal of magnesium fluoride can be used for a rare gas excimer lamp, VUV deuterium lamp, etc. In addition to its excellent optical property, the single crystal has a large diameter and is, therefore, also useful as an optical member of an exposing apparatus. In particular, the single crystal of magnesium fluoride can be preferably used as a polarizer element in a polarized illumination system.

### EXAMPLES

The invention will be further described by way of Examples to which only, however, the invention is in no way limited. Further, it does not mean that combinations of features described in Examples are all essential as means for solving the problems of the invention.

The internal transmittance in the vacuum ultraviolet region (hereinafter simply as VUV transmittance) and the laser induced absorption that serves as an index of long term laser durability were evaluated as described below.

### (1) Measuring the VUV Transmittance.

A sample having a thickness of 1.0 cm was prepared by polishing the surface until the surface roughness was 0.5 nm or less in terms of RMS. The sample was washed by ultrasonic waves in acetone for 2 minutes, dried and was, thereafter, washed by ultraviolet rays of an output of 7 mW/cm² for 15 minutes by using an ultraviolet ray ozone washing apparatus (UV-208 manufactured by Technovision. Inc.) using a low-pressure mercury lamp as a source of light. Next, the washed sample was measured for its transmittance over a range of 120 to 210 nm by using a VUV transmittance-measuring apparatus (KV-201 manufactured by JASCO Co.) in a nitrogen atmosphere containing not more than 0.2 ppm of oxygen.

### (2) Measuring the Laser Induced Absorption.

The sample that was measured for its VUV transmittance was subjected again to the ultraviolet ray ozone washing and was, thereafter, measured for its transmittance over a range of 200 to 800 nm by using an ultraviolet visible spectrophotometer (UV-1650 manufactured by SHIMADZU Co.). Next, by using a light source device of ArF excimer laser (Novaline A 2030 manufactured by Coherent Inc.), 2 million pulses of a laser of an energy density of 30 mJ/cm² were irradiated at repetition rate of 2000 Hz. The transmittance over a range of 200 to 800 nm immediately after irradiated with the laser was measured again by using the above apparatus. A difference in the transmittance before and after irradiated with the laser was found, and an absorbance calculated from the differential transmittance was regarded as a laser induced absorption. The smaller the laser induced absorption, the smaller the change in the transmittance before and after irradiated with the laser, i.e., the more excellent the long term laser durability. The magnesium fluoride for vacuum ultraviolet ray transmittance exhibits a spectrum having a peak at 255 nm. Therefore, the long term laser durabilities can be compared if the heights of absorption at 255 nm are compared.

### Experiment 1 (φ10 cm).

A single crystal of magnesium fluoride was produced by using a growing furnace for producing single crystal having a resistance-type heater as schematically shown in FIG. 1.

<Furnace that was Used>

In the growing furnace for producing single crystal, an outer crucible (1) made of a highly pure graphite is installed in a chamber (4), and has an inner diameter of 22.5 cm, an outer diameter of 23.8 cm and a height of 17 cm. An inner crucible is hung in the outer crucible (1) by using a hanging rod (20) fixed to a lid member (18), and is fixed therein. The inner crucible (2) has an inner diameter of 18 cm, an outer diameter of 19.2 cm and a height of 9.4 cm.

The bottom wall of the inner crucible has a V-shape (mortar shape) in vertical cross section being tilted downward at a tilting angle of 30 degrees from the horizontal plane. A communication hole (3) of a cylindrical shape having a diameter of 6 mm is formed in the lower end of the inner crucible. A heat-insulating wall (8) is made of a pitch-type graphite-molded heat-insulating member, and has an inner diameter of 40 cm. A heat-insulating lid member (21) has an inner diameter of 30 cm and has its lower surface at a position 19 cm over the surface of the melt of the starting material. The heat-insulating lid member has a heat radiating ability of 9 W/m² K in the direction of thickness. A ceiling plate (16) is made of graphite plates in a double structure and has a heat radiating ability of 5000 W/m² K in the direction of thickness. A space of 2 cm is maintained between the lower surface of the ceiling plate and the upper end of the heat-insulating member (see JP2009-102194).

### <Initial Step>

Into the outer crucible (1), there were introduced a total of 6.0 kg of masses of starting magnesium fluoride that have been fully purified and from which water has been removed. Further, a total of 3.0 g of a ZnF₂ powder was introduced into a groove formed in a crucible bedplate (6). By using an oil rotary pump and an oil diffusion pump, the interior of the chamber (4) was evacuated down to not higher than 1×10⁻³ Pa and, thereafter, the heating was started. The temperature was elevated up to 250 and was maintained at this temperature for 20 hours. Thereafter, the temperature was elevated up to 600 and was maintained at this temperature for 28 hours.

### <Melting Step>

Next, an argon gas 50 kPa was fed into the furnace. Thereafter, the temperature was elevated up to 1300 to melt the starting magnesium fluoride. After the starting material was completely melted, the support shaft was moved up to let the melt of magnesium fluoride flow into the inner crucible. The outer crucible and the inner crucible containing the melt of magnesium fluoride therein were maintained for one hour.

### <Growing Step>

The surface state of the melt (12) contained in the inner crucible was watched through a view window (14) and it was confirmed that solid impurities had been floating. Therefore, the support shaft (5) was moved down to let the whole amount of the melt contained in the inner crucible flow out into the outer crucible. Thereafter, the operation was conducted to move the support shaft up again to let the melt in the outer crucible flow into the inner crucible. The surface state of the melt contained in the inner crucible was watched again through the view window. At this time, no solid impurity was confirmed. The melt of magnesium fluoride in the inner crucible was 4 cm deep. In this state, the distance was 19 cm from the surface of melt of magnesium fluoride to the lower end surface of the heat-insulating lid member.

Next, the temperature was lowered down to 1265 and was maintained at this temperature for one hour. Thereafter, a single crystal pulling rod (11) was hanged down to bring a seed crystal (9) into contact with the surface of the melt (12) of magnesium fluoride to start pulling up a single crystal. The seed crystal that was used was a magnesium fluoride single crystal with its lower end face being a crystal plane (001). The single crystal was pulled up in a state where the single crystal pulling rod (seed crystal) was rotated 8 turns/min. The pulling rate was 2 mm/hr. During the pulling up, the support shaft was continuously so moved up that the depth of the melt in the inner crucible was maintained to be 4 cm. After having been pulled up, the support shaft was moved down to let the remaining melt of magnesium fluoride flow out into the outer crucible. Thereafter, the temperature was cooled down to room temperature at a cooling rate of 0.67/min.

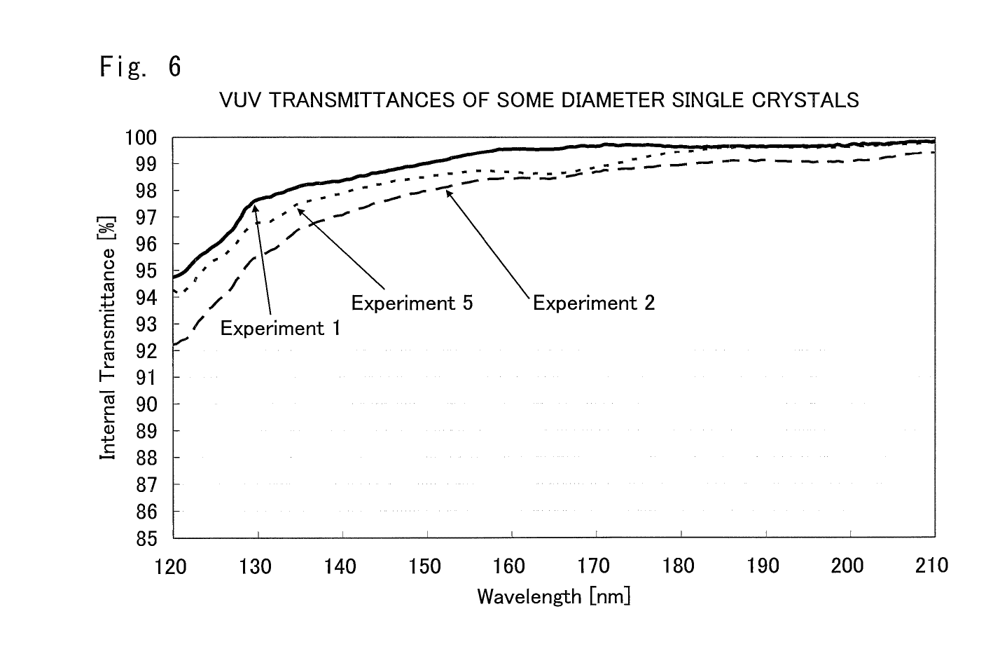

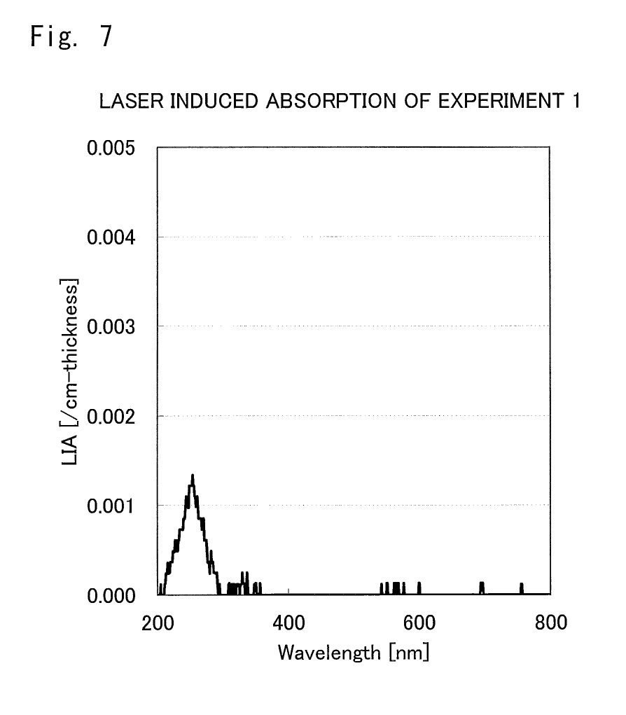

Through the above operation, there was obtained a (001) as-grown crystal of magnesium fluoride having a diameter at the straight body portion of 10 0.2 cm, a length of the straight body portion of 10 cm and a weight of 2.9 Kg. In the straight body portion of 10 cm, the temperature gradient in the longitudinal direction in the single crystal growth area was in a range of 5 to 8 deg/cm. Next, the crystal was sliced along a plane perpendicular to the direction of growth, and was measured for its VUV transmittance and laser induced absorption. The results were as shown in Table 1 and in FIGS. 6 and 7.

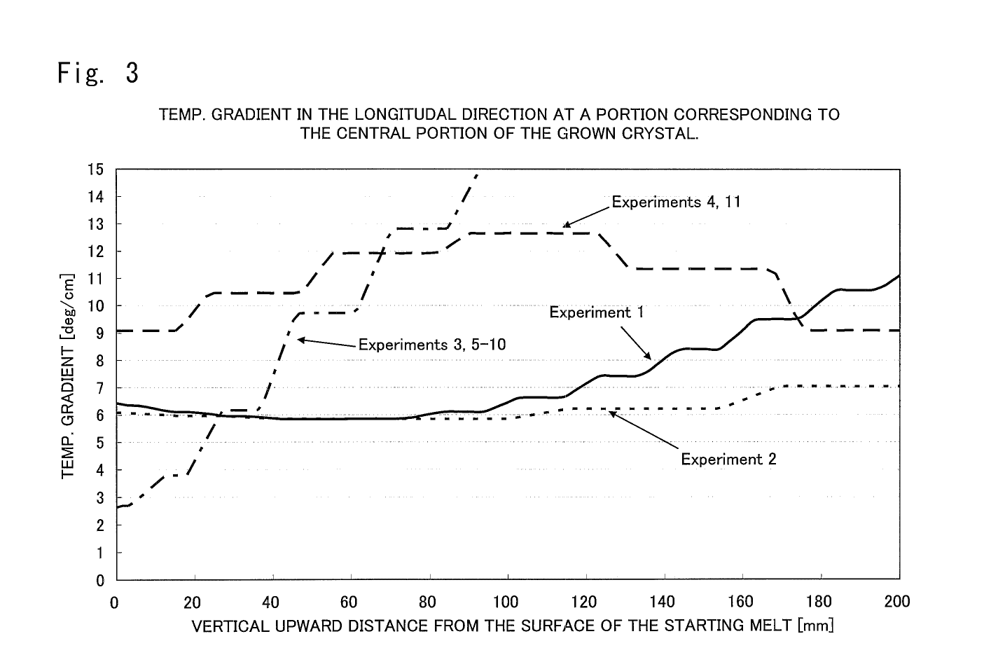

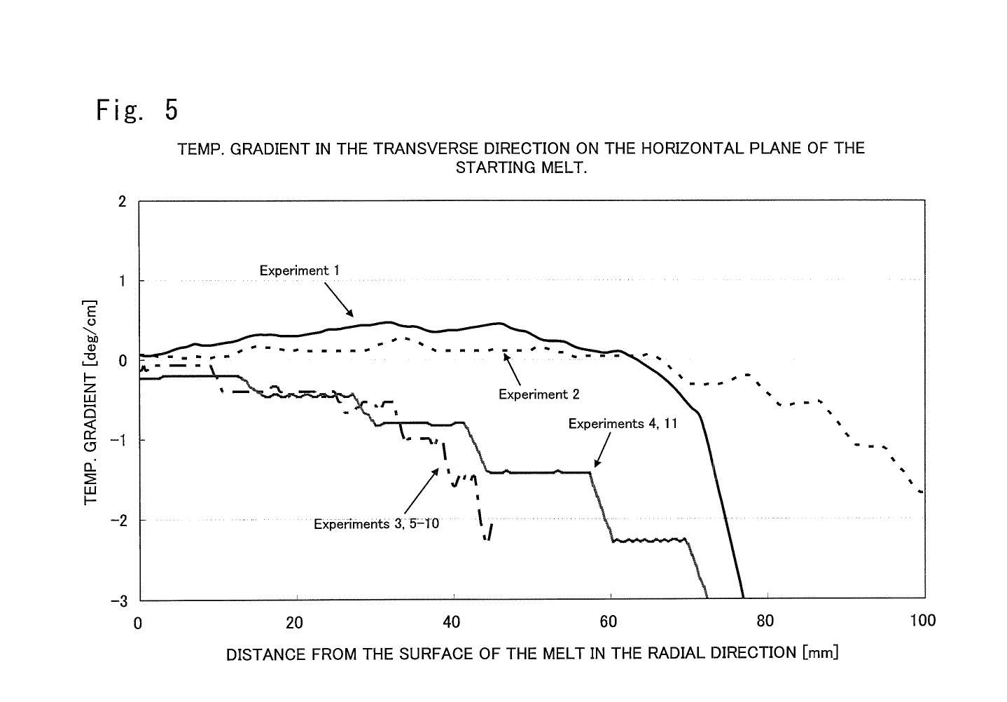

The simulated results of temperature gradient in the single crystal growth area under the above single crystal production conditions by using the CrysMAS were as shown in FIGS. 3 to 5.

### Experiment 2 (15 cm).

A single crystal of magnesium fluoride was produced by using a growing furnace for producing single crystal having a resistance-type heater as schematically shown in FIG. 1.

<Furnace that was Used>

In the growing furnace for producing single crystal, an outer crucible made of a highly pure graphite is installed in a chamber, and has an inner diameter of 36 cm, an outer diameter of 38 cm and a height of 27 cm. An inner crucible is hung in the outer crucible by using a hanging rod fixed to a lid member, and is fixed therein. The inner crucible has an inner diameter of 25 cm, an outer diameter of 26 cm and a height of 13 cm.

The bottom wall of the inner crucible has a V-shape (mortar shape) in vertical cross section being tilted downward at a tilting angle of 30 degrees from the horizontal plane. A communication hole of a cylindrical shape having a diameter of 6 mm is formed in the lower end of the inner crucible. A heat-insulating wall is made of a pitch-type graphite-molded heat-insulating member, and has an inner diameter of 55 cm. A heat-insulating lid member has an inner diameter of 48 cm and is installed at a position 25 cm over the surface of the melt of the starting material. The heat-insulating lid member has a heat radiating ability of 9 W/m² K in the direction of thickness. A ceiling plate is made of graphite plates in a double structure and has a heat radiating ability of 5000 W/m² K in the direction of thickness. A space of 3 cm is maintained between the lower surface of the ceiling plate and the upper end surface of the heat-insulating member. Other constitutions are the same as those of Experiment 1.

### <Initial Step>

Into the outer crucible, there were introduced a total of 20 kg of masses of starting magnesium fluoride that have been fully purified and from which water has been removed. Further, a total of 12.0 g of a ZnF₂ powder was introduced into a groove formed in a crucible bedplate. By using an oil rotary pump and an oil diffusion pump, the interior of the chamber was evacuated down to not higher than 1×10⁻³ Pa and, thereafter, the heating was started. The temperature was elevated up to 300 and was maintained at this temperature for 21 hours. Thereafter, the temperature was elevated up to 500 and was maintained at this temperature for 21 hours.

### <Melting Step>

Next, an argon gas 45 kPa was fed into the furnace. Thereafter, the temperature was elevated up to 1300 to melt the starting magnesium fluoride. After the starting material was completely melted, the support shaft was moved up to let the melt of magnesium fluoride flow into the inner crucible. The outer crucible and the inner crucible containing the melt of magnesium fluoride therein were maintained for one hour.

### <Growing Step>

The surface state of the melt contained in the inner crucible was watched through a view window and it was confirmed that solid impurities had been floating. Therefore, the support shaft was moved down to let the whole amount of the melt contained in the inner crucible flow out into the outer crucible. Thereafter, the operation was conducted to move the support shaft up again to let the melt in the outer crucible flow into the inner crucible. The surface state of the melt contained in the inner crucible was watched again through the view window. At this time, no solid impurity was confirmed. The melt of magnesium fluoride in the inner crucible was 6.5 cm deep. In this state, the distance was 25 cm from the surface of melt of magnesium fluoride to the lower end surface of the heat-insulating lid member.

Next, the temperature was lowered down to 1265 and was maintained at this temperature for one hour. Thereafter, a single crystal pulling rod was hanged down to bring the lower end face (single crystal growing face) which was the crystal plane (001) of a seed crystal into contact with the surface of the melt of magnesium fluoride to start pulling up a single crystal. The single crystal was pulled up in a state where the single crystal pulling rod (seed crystal) was rotated 8 turns/min. The pulling rate was 2 mm/hr. During the pulling up, the support shaft was continuously so moved up that the depth of the melt in the inner crucible was maintained to be 6.5 cm. After having been pulled up, the support shaft was moved down to let the remaining melt of magnesium fluoride flow out into the outer crucible. Thereafter, the temperature was cooled down to room temperature at a cooling rate of 0.67/min.

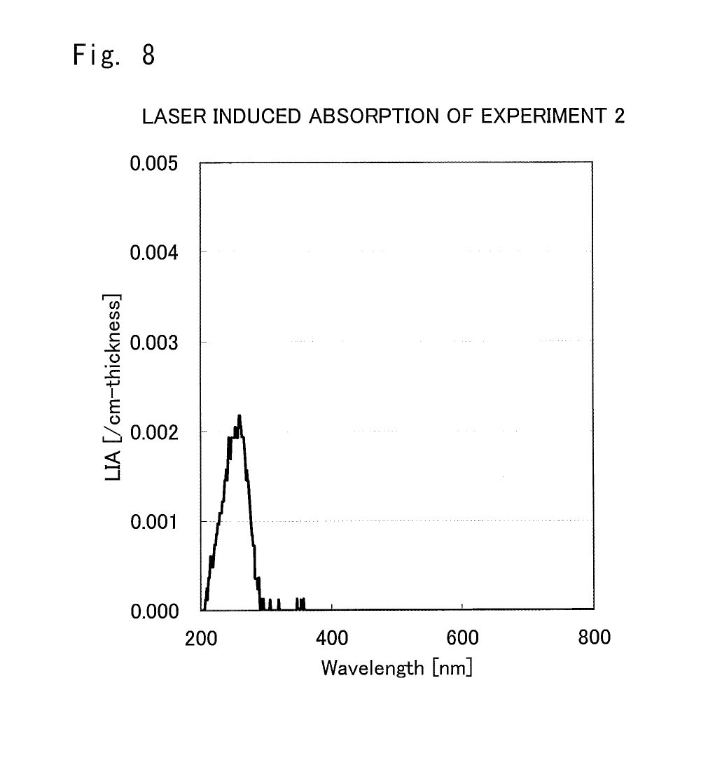

Through the above operation, there was obtained a (001) as-grown crystal of magnesium fluoride having a diameter at the straight body portion of 10 0.3 cm, a length of the straight body portion of 15 cm and a weight of 10.8 Kg. In the straight body portion of 15 cm, the temperature gradient in the longitudinal direction in the single crystal growth area was in a range of 5 to 8 deg/cm. Next, the crystal was sliced along a plane perpendicular to the direction of growth, and was measured for its VUV transmittance and laser induced absorption. The results were as shown in Table 1 and in FIGS. 6 and 8.

The simulated results of temperature gradient in the single crystal growth area under the above single crystal production conditions by using the CrysMAS were as shown in FIGS. 3 to 5.

### Experiment 3 (5 cm: Production by Also Using CF₄).

A single crystal of magnesium fluoride was produced by using a growing furnace for producing single crystal having a resistance-type heater as schematically shown in FIG. 2.

<Furnace that was Used>

In the growing furnace for producing single crystal, an outer crucible made of a highly pure graphite is installed in a chamber, and has an inner diameter of 12 cm, an outer diameter of 13 cm and a height of 12.7 cm. An inner crucible is hung in the outer crucible by using a hanging rod fixed to a lid member, and is fixed therein. The inner crucible has an inner diameter of 9 cm, an outer diameter of 10 cm and a height of 6.7 cm.

The bottom wall of the inner crucible has a V-shape (mortar shape) in vertical cross section being tilted downward at a tilting angle of 45 degrees from the horizontal plane. A communication hole of a cylindrical shape having a diameter of 6 mm is formed in the lower end of the inner crucible. A heat-insulating wall is made of a pitch-type graphite-molded heat-insulating member, and has an inner diameter of 25 cm. A heat radiating ability thereof in the direction of thickness is 9 W/m² K. A ceiling plate is made of graphite and has a heat radiating ability of 5000 W/m² K in the direction of thickness.

### <Initial Step>

Into the outer crucible, there were introduced a total of 1.2 kg of masses of starting magnesium fluoride that have been fully purified and from which water has been removed. Further, a total of 0.6 g of a ZnF₂ powder was introduced into a groove formed in a crucible bedplate. By using an oil rotary pump and an oil diffusion pump, the interior of the chamber was evacuated down to not higher than 1×10⁻³ Pa and, thereafter, the heating was started. The temperature was elevated up to 250 and was maintained at this temperature for 19 hours. Thereafter, the temperature was elevated up to 600 and was maintained at this temperature for 20 hours.

### <Melting Step>

Next, a carbon tetrafluoride 10 kPa and an argon gas 40 kPa were fed into the furnace. Thereafter, the temperature was elevated up to 1300 to melt the starting magnesium fluoride. After the starting material was completely melted, the support shaft was moved up to let the melt of magnesium fluoride flow into the inner crucible. The outer crucible and the inner crucible containing the melt of magnesium fluoride therein were maintained for one hour.

### <Growing Step>

The surface state of the melt contained in the inner crucible was watched through a view window and it was confirmed that solid impurities had been floating. Therefore, the support shaft was moved down to let the whole amount of the melt contained in the inner crucible flow out into the outer crucible. Thereafter, the operation was conducted to move the support shaft up again to let the melt in the outer crucible flow into the inner crucible. The surface state of the melt contained in the inner crucible was watched again through the view window. At this time, no solid impurity was confirmed. The melt of starting magnesium fluoride in the inner crucible was 4 cm deep.

Next, the temperature was lowered down to 1265 and was maintained at this temperature for one hour. Thereafter, a single crystal pulling rod was hanged down to bring the lower end face (single crystal growing face) which was the crystal plane (001) of a seed crystal into contact with the surface of the melt of magnesium fluoride to start pulling up a single crystal. The single crystal was pulled up in a state where the single crystal pulling rod (seed crystal) was rotated 15 turns/min. The pulling rate was 2 mm/hr. During the pulling up, the support shaft was continuously so moved up that the depth of the melt in the inner crucible was maintained to be 4 cm. After having been pulled up, the support shaft was moved down to let the remaining melt of magnesium fluoride flow out into the outer crucible. Thereafter, the temperature was cooled down to room temperature at a cooling rate of 1.34/min.

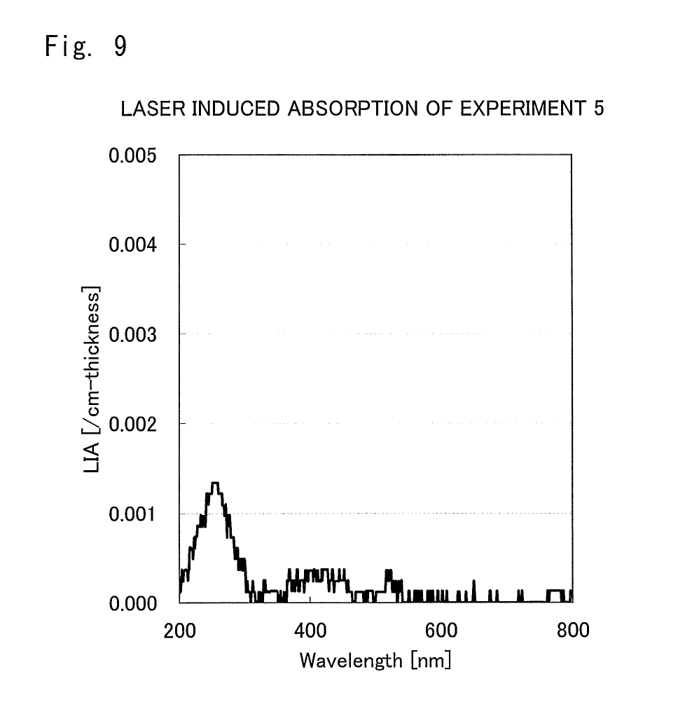

Through the above operation, there was obtained a (001) as-grown crystal of magnesium fluoride having a diameter at the straight body portion of 5 0.1 cm, a length of the straight body portion of 5 cm and a weight of 0.38 Kg. The crystal was sliced along a plane perpendicular to the direction of growth, and was measured for its VUV transmittance and laser induced absorption. The results were as shown in Table 1 and in FIGS. 6 and 9.

The simulated results of temperature gradient in the single crystal growth area under the above single crystal production conditions by using the CrysMAS were as shown in FIGS. 3 to 5.

### Experiment 4.

It was attempted to produce a single crystal of magnesium fluoride by the same method as that of Experiment 1 but installing the heat-insulating lid member at a position 9 cm over the surface of the starting melt. However, polycrystallization occurred from nearly 4cm of length of the straight body portion, and cracks propagated into the crystal. As a result, a single crystal could not be produced.

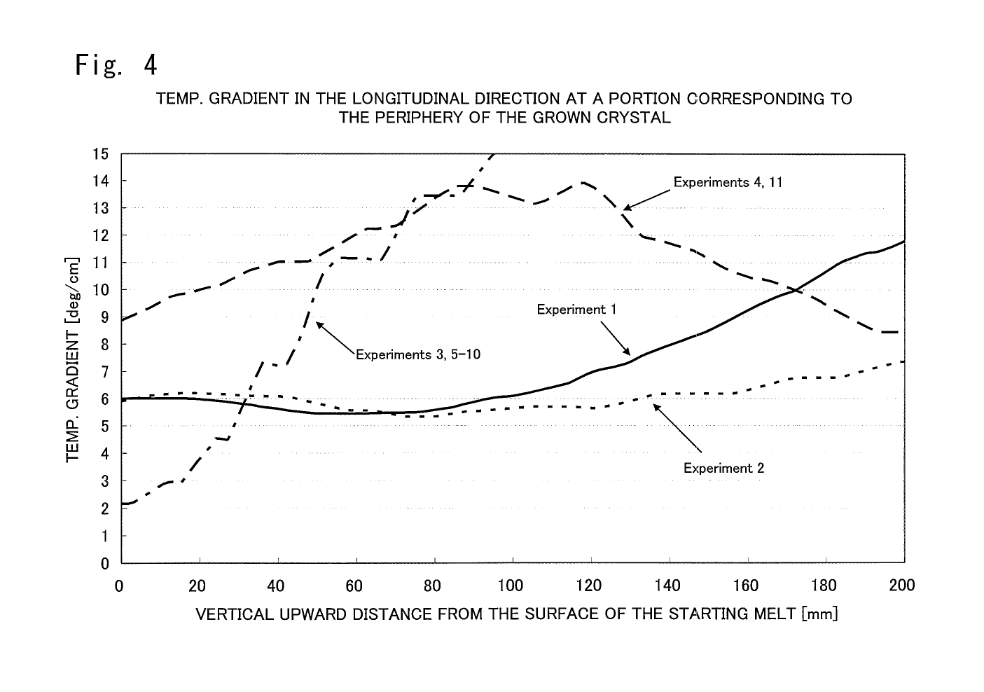

In this constitution, the position of the heat-insulating lid member was so low that the temperature gradient was steep in the single crystal growth area (see FIGS. 3 and 4). The above 4 cm of length of the straight body portion is a point where the temperature gradient in the longitudinal direction in the single crystal growth area starts deviating from the range of 5 to 10 deg/cm.

Thus, the single crystal of magnesium fluoride of a large diameter could not be produced by using the furnace in which the temperature gradient was deviated from the range of 5 to 10 deg/cm.

### Experiment 5 (5 cm).

A single crystal of magnesium fluoride was produced by using a growing furnace for producing single crystal having a resistance-type heater as schematically shown in FIG. 2.

<Furnace that was Used>

In the growing furnace for producing single crystal, an outer crucible made of a highly pure graphite is installed in a chamber, and has an inner diameter of 12 cm, an outer diameter of 13 cm and a height of 12.7 cm. An inner crucible is hung in the outer crucible by using a hanging rod fixed to a lid member, and is fixed therein. The inner crucible has an inner diameter of 9 cm, an outer diameter of 10 cm and a height of 6.7 cm.

The bottom wall of the inner crucible has a V-shape (mortar shape) in vertical cross section being tilted downward at a tilting angle of 45 degrees from the horizontal plane. A communication hole of a cylindrical shape having a diameter of 6 mm is formed in the lower end of the inner crucible. Other constitutions are the same as those of Experiment 3.

### <Initial Step>

Into the outer crucible, there were introduced a total of 1.2 kg of masses of starting magnesium fluoride that have been fully purified and from which water has been removed. Further, a total of 0.6 g of a ZnF₂ powder was introduced into a groove formed in a crucible bedplate. By using an oil rotary pump and an oil diffusion pump, the interior of the chamber was evacuated down to not higher than 1×10⁻³ Pa and, thereafter, the heating was started. The temperature was elevated up to 250 and was maintained at this temperature for 20 hours. Thereafter, the temperature was elevated up to 600 and was maintained at this temperature for 20 hours.

### <Melting Step>

Next, an argon gas 50 kPa was fed into the furnace. Thereafter, the temperature was elevated up to 1300 to melt the starting magnesium fluoride. After the starting material was completely melted, the support shaft was moved up to let the melt of magnesium fluoride flow into the inner crucible. The outer crucible and the inner crucible containing the melt of magnesium fluoride therein were maintained for one hour.

### <Growing Step>

The surface state of the melt contained in the inner crucible was watched through a view window and it was confirmed that solid impurities had been floating. Therefore, the support shaft was moved down to let the whole amount of the melt contained in the inner crucible flow out into the outer crucible. Thereafter, the operation was conducted to move the support shaft up again to let the melt in the outer crucible flow into the inner crucible. The surface state of the melt contained in the inner crucible was watched again through the view window. At this time, no solid impurity was confirmed. The melt of starting magnesium fluoride in the inner crucible was 4 cm deep. Next, the temperature was lowered down to 1265 and was maintained at this temperature for one hour. Thereafter, a single crystal pulling rod was hanged down to bring the lower end face (single crystal growing face) which was the crystal plane (001) of a seed crystal into contact with the surface of the melt of magnesium fluoride to start pulling up a single crystal. The single crystal was pulled up in a state where the single crystal pulling rod was rotated 15 turns/min. The pulling rate was 2 mm/hr. During the pulling up, the support shaft was continuously so moved up that the depth of the melt in the inner crucible was maintained to be 4 cm. The support shaft was moved down to let the remaining melt of starting magnesium fluoride flow out into the outer crucible. Thereafter, the temperature was cooled down to room temperature at a cooling rate of 1.34/min.

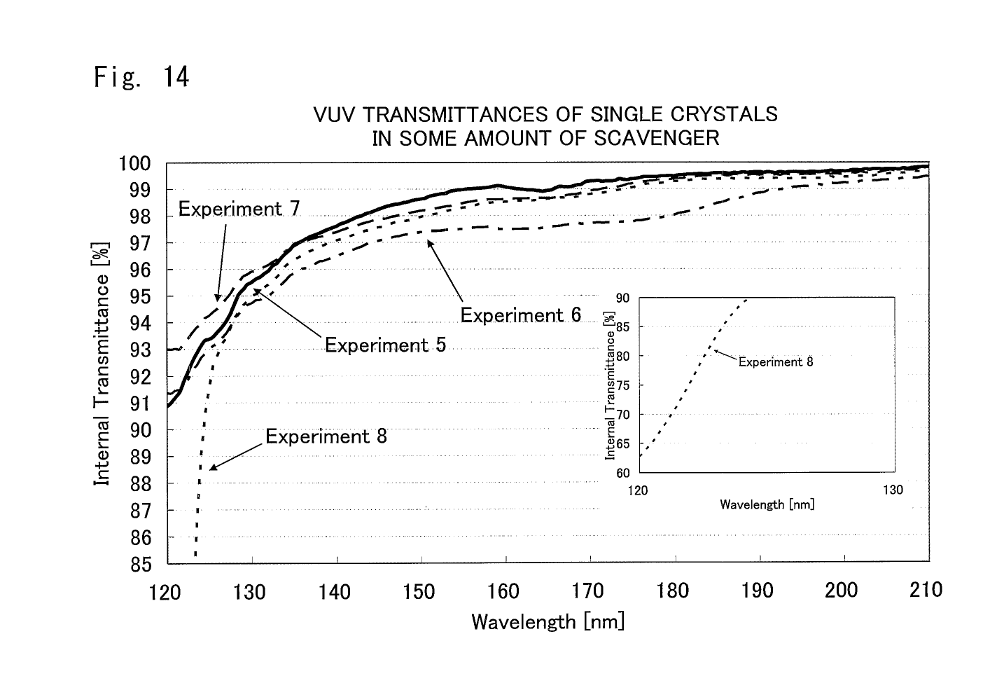

Through the above operation, there was obtained a (001) as-grown crystal of magnesium fluoride having a diameter at the straight body portion of 5 0.1 cm, a length of the straight body portion of 5 cm and a weight of 0.38 Kg. The crystal was sliced along a plane perpendicular to the direction of growth, and was measured for its VUV transmittance and laser induced absorption. The results were as shown in Table 1 and in FIGS. 6, 9, 10 and 14.

The simulated results of temperature gradient in the single crystal growth area under the above single crystal production conditions by using the CrysMAS were as shown in FIGS. 3 to 5.

### Experiments 6 to 10.

Single crystals of magnesium fluoride were produced by the same method as that of Experiment 5 but changing the amount of ZnF₂ powder used in the initial step and the amount of gas introduced into the furnace in the melting step as described in Table 1.

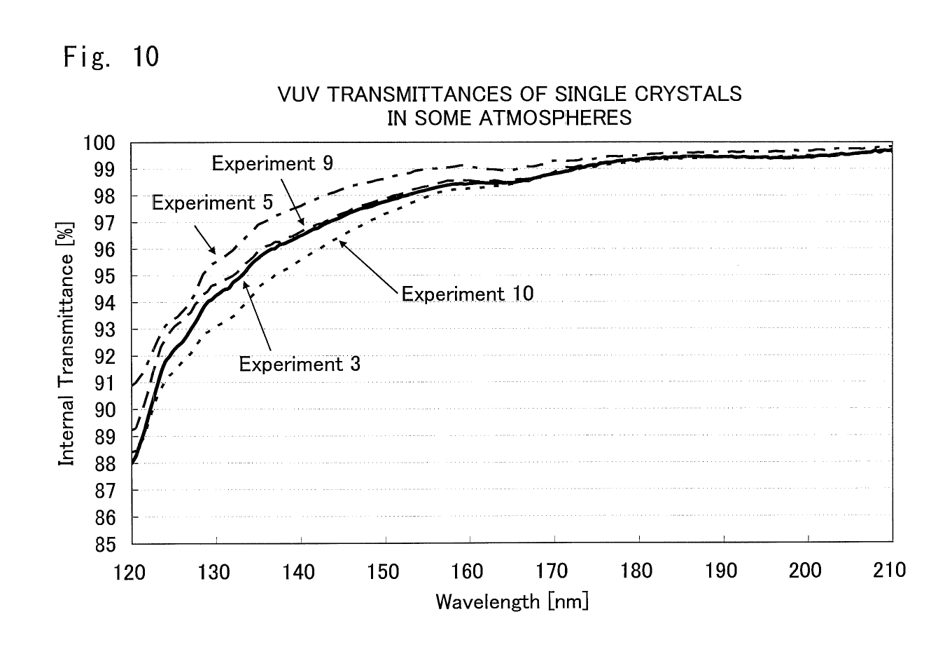

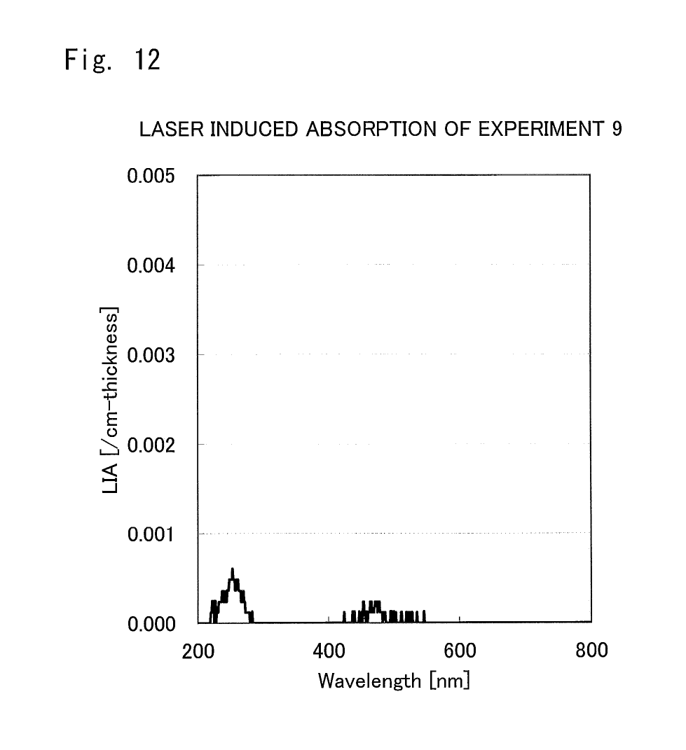

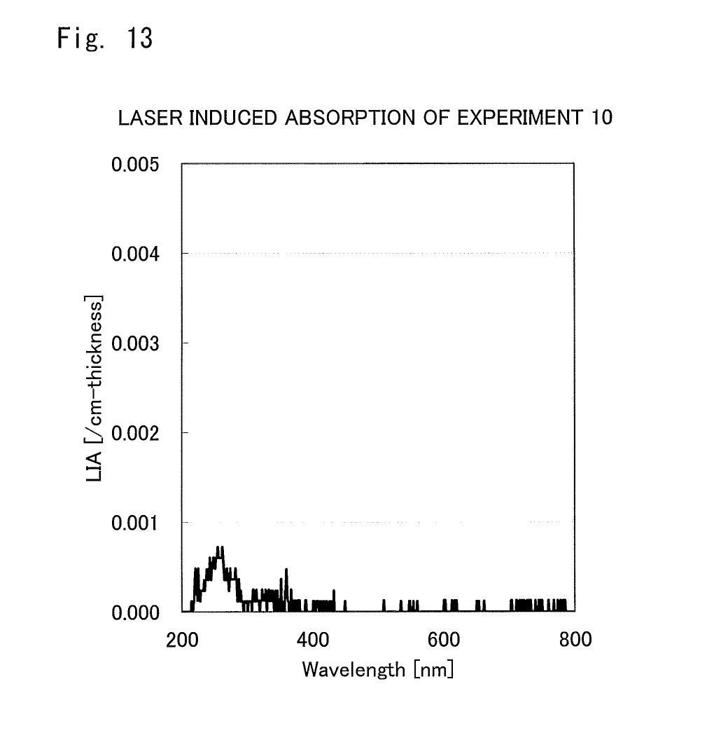

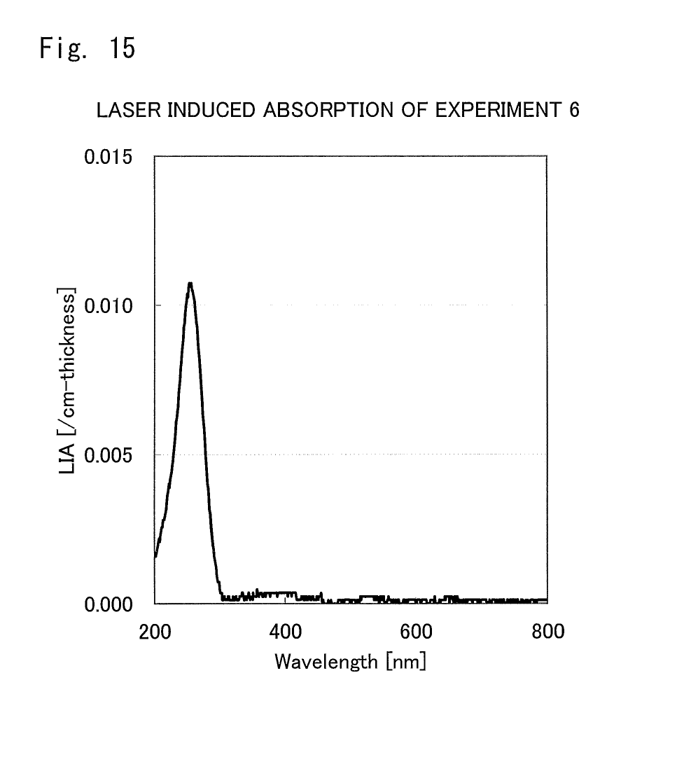

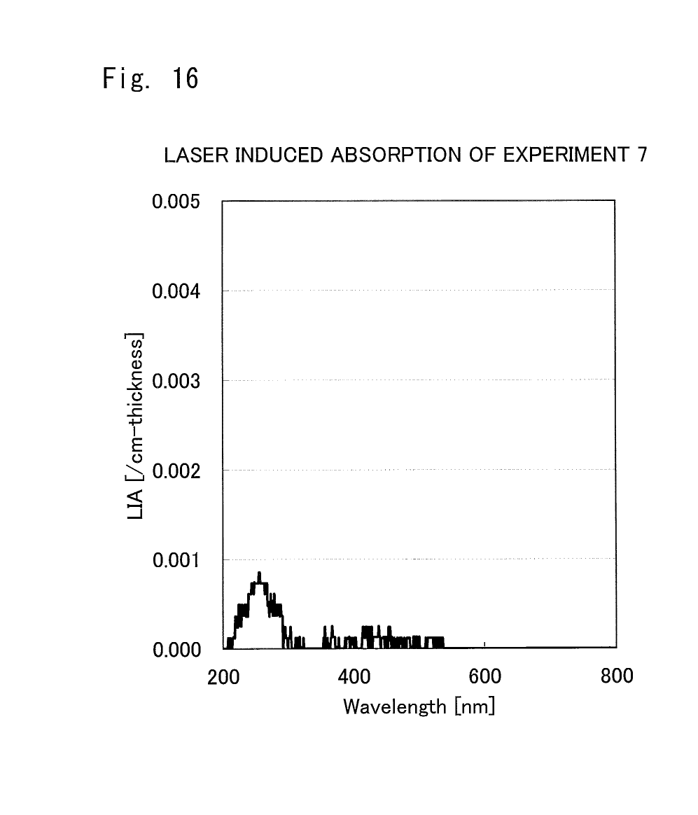

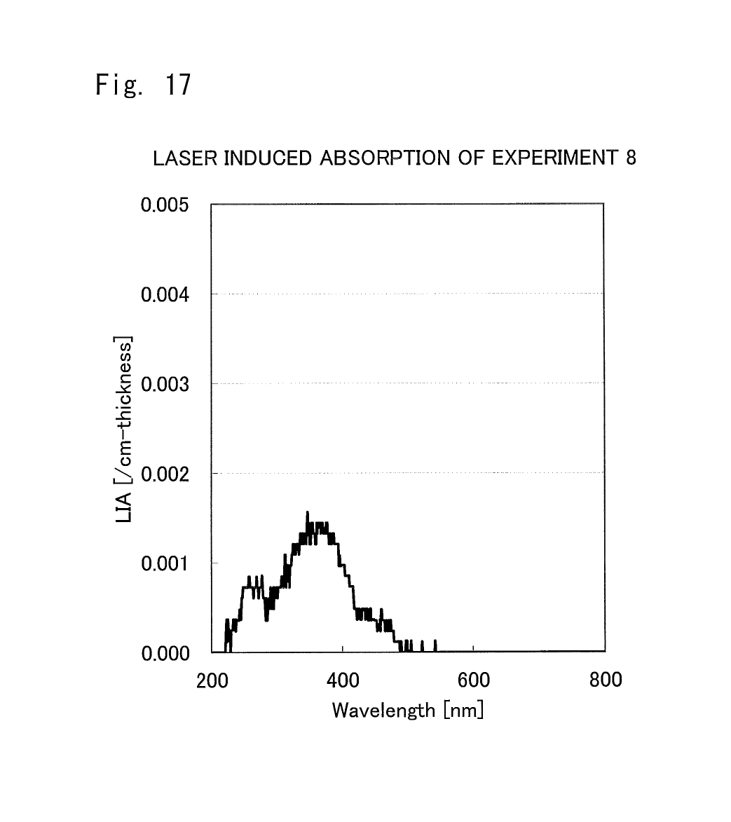

The obtained single crystals were measured for their VUV transmittance and laser induced absorptions to obtain results as shown in Table 1 and in FIGS. 10, 12 to 17.

### Experiment 11 (Reference Experiment)

Single crystal of calcium fluoride was produced by the same method as that of Experiment 4 but changing the amount of starting material and ZnF₂ powder. Calcium fluoride was introduced 10 kg and ZnF₂ powder was 4.0 g. There was obtained a single crystal of calcium fluoride having a diameter at the straight body portion of 12±0.4 cm and a length of the straight body portion of 7 cm and a weight of 4.0 kg.

TABLE 1

| | | Length | | | | | | |
|---|---|---|---|---|---|---|---|---|
| | | of | | Amount of | Amount of | VUV transmittance | | |
| | | straight | Amount | Ar | CF₄ | (%) | | Laser induced |
| | Diameter | body | of ZnF₂ | introduced | introduced | *1: | *1: | absorption |
| | (cm) | (cm) | (mol %) | (kPa) | (kPa) | 120 nm | 193 nm | *1: 255 nm |
| Expt. 1 | 10 | 10 | 0.030 | 50 | 0 | 94.75 | 99.68 | 0.00122 |
| Expt. 2 | 15 | 15 | 0.030 | 45 | 0 | 92.36 | 99.09 | 0.00193 |
| Expt. 3 | 5 | 5 | 0.030 | 40 | 10 | 88.01 | 99.42 | 0.00037 |
| Expt. 4 | — | — | 0.030 | 50 | 0 | *2 | *2 | *2 |
| Expt. 5 | 5 | 5 | 0.030 | 50 | 0 | 90.87 | 99.62 | 0.00134 |
| Expt. 6 | 5 | 5 | 0 | 50 | 0 | 91.37 | 99.00 | 0.01062 |
| Expt. 7 | 5 | 5 | 0.006 | 50 | 0 | 93.00 | 99.56 | 0.00085 |
| Expt. 8 | 5 | 5 | 0.300 | 50 | 0 | 62.76 | 99.42 | 0.00072 |
| Expt. 9 | 5 | 5 | 0.030 | 48 | 2 | 89.24 | 99.45 | 0.00049 |
| Expt. 10 | 5 | 5 | 0.030 | 30 | 20 | 88.42 | 99.43 | 0.00072 |

*1: Measured wavelength
*2: single crystal could not be grown

1. A single crystal of magnesium fluoride of a cylindrical shape having a straight body portion of a diameter of not smaller than 10 cm, and having an internal transmittance of at least 85.00%/cm at 120 nm and at least 98.00%/cm at 193 nm.

2. An optical member for vacuum ultraviolet ray transmittance, comprising the single crystal of magnesium fluoride of claim 1.

3. An optical element for optical lithography, comprising the single crystal of magnesium fluoride of claim 1.

4. The single crystal of magnesium fluoride according to claim 1, wherein a laser induced absorption at 255 nm is not larger than 0.0030 absorption/cm immediately after the irradiation with 2 million shots of an ArF excimer laser of an energy density of 30 mJ/cm² and 2000 Hz.

5. A single crystal of magnesium fluoride having a laser induced absorption at 255 nm of not larger than 0.0030 absorption/cm immediately after the irradiation with 2 million shots of an ArF excimer laser of an energy density of 30 mJ/cm² and 2000 Hz.

6. The single crystal of magnesium fluoride according to claim 5, wherein the laser induced absorption is not larger than 0.0010 absorption/cm.

7. An optical member for vacuum ultraviolet ray transmission, comprising the single crystal of magnesium fluoride of claim 5.

8. An optical element for optical lithography, comprising the single crystal of magnesium fluoride of claim 5.

9. An optical lithographic apparatus using the optical element for optical lithography of claim 8.
